(19) United States
(12) Patent Application Publication
(10) Pub. No.: US 2024/0169733 A1
(43) Pub. Date: May 23, 2024

(54) METHOD AND ELECTRONIC DEVICE WITH VIDEO PROCESSING

(71) Applicant: Samsung Electronics Co., Ltd., Suwon-si (KR)

(72) Inventors: Yi ZHOU, Beijing (CN); Seung-In PARK, Suwon-si (KR); Byung In YOO, Suwon-si (KR); Sangil JUNG, Suwon-si (KR); Hui ZHANG, Beijing (CN)

(73) Assignee: Samsung Electronics Co., Ltd., Suwon-si (KR)

(21) Appl. No.: 18/514,455

(22) Filed: Nov. 20, 2023

(30) Foreign Application Priority Data
Nov. 18, 2022 (CN) 202211449589.4
Aug. 24, 2023 (KR) 10-2023-0111343

(51) Int. Cl. G06V 20/40; G06V 10/77; G06V 10/774; G06V 10/776; G06V 10/82; G06V 20/70

(52) U.S. Cl. CPC G06V 20/49; G06V 10/7715; G06V 10/774; G06V 10/776; G06V 10/82; G06V 20/41; G06V 20/46; G06V 20/70

(57) ABSTRACT

A processor-implemented method includes: obtaining a video feature of a video comprising a plurality of video frames; determining a target object representation of the video based on the video feature using a neural network; and generating a panorama segmentation result of the video based on the target object representation.

### CROSS-REFERENCE TO RELATED APPLICATIONS

This application claims the benefit under 35 USC § 119(a) of Chinese Patent Application No. 202211449589.4 filed on Nov. 18, 2022 in the China National Intellectual Property Administration, and Korean Patent Application No. 10-2023-0111343 filed on Aug. 24, 2023 in the Korean Intellectual Property Office, the entire disclosures of which are incorporated herein by reference for all purposes.

### BACKGROUND

### 1. Field

The following description relates to a method and electronic device with video processing.

### 2. Description of Related Art

Panoptic segmentation may include a process of assigning label information to each pixel of a two-dimensional (2D) image. Panorama segmentation of a video may include an expansion of panoramic segmentation in the time domain that combines a task of tracking an object in addition to panoramic segmentation for each image, e.g., a task of assigning the same label to pixels belonging to the same instance in different images.

In video panorama segmentation technology, the accuracy of panorama segmentation may be low when determining the representation of a panoramic object for a single frame image. When an additional tracking module is required to obtain correspondence information between each video frame of a video, a network structure may be complicated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: obtaining a video feature of a video comprising a plurality of video frames; determining a target object representation of the video based on the video feature using a neural network; and generating a panorama segmentation result of the video based on the target object representation.

The determining of the target object representation of the video based on the video feature using the neural network may include determining the target object representation of the video by performing multiple iteration processing on the video feature using the neural network.

The determining of the target object representation of the video by performing the multiple iteration processing on the video feature using the neural network may include determining an object representation by current iteration processing of the video by performing iteration processing based on the video feature and an object representation by previous iteration processing of the video, using the neural network.

The object representation by the previous iteration processing may be a pre-configured initial object representation in a case of first iteration processing of the multiple iteration processing.

The determining of the object representation by the current iteration processing of the video by performing the iteration processing based on the video feature and the object representation by the previous iteration processing of the video may include: generating a mask by performing transformation processing on the object representation by the previous iteration processing of the video; generating a first object representation by processing the video feature, the object representation by the previous iteration processing, and the mask; and determining the object representation by the current iteration processing of the video based on the first object representation.

The generating of the first object representation by processing the video feature, the object representation by the previous iteration processing, and the mask may include: generating an object representation related to a mask by performing attention processing on the video feature, the object representation by the previous iteration processing, and the mask; and generating the first object representation by performing self-attention processing and classification processing based on the object representation related to the mask and the object representation by the previous iteration processing.

The generating of the object representation related to the mask by performing the attention processing on the video feature, the object representation by the previous iteration processing, and the mask may include: generating a second object representation based on a key feature corresponding to the video feature, the object representation by the previous iteration processing, and the mask; determining a first probability indicating an object category in the video based on the second object representation; and generating the object representation related to the mask based on the first probability, a value feature corresponding to the video feature, and the video feature.

The determining of the object representation by the current iteration processing of the video based on the first object representation may include: determining an object representation corresponding to each video frame of one or more video frames of the plurality of video frames, based on the video feature and the first object representation; and determining the object representation by the current iteration processing of the video based on the first object representation and the determined object representation corresponding to the each video frame.

The determining of the object representation corresponding to each video frame of the one or more video frames based on the video feature and the first object representation may include: determining a fourth object representation based on a key feature corresponding to the video feature and the first object representation; determining a second probability indicating an object category in the video based on the fourth object representation; and determining the object representation corresponding to each video frame of the one or more video frames based on the second probability and a value feature corresponding to the video feature.

The determining of the object representation by the current iteration processing of the video based on the first object representation and the determined object representation corresponding to the each video frame may include: generating a third object representation corresponding to the video by performing classification processing and self-attention processing on the determined object representation corresponding to the each video frame; and determining the object representation by the current iteration processing of the video based on the first object representation and the third object representation.

The generating of the panorama segmentation result of the video based on the target object representation may include: performing linear transformation processing on the target object representation; and determining mask information of the video based on the linear transformation-processed target object representation and the video feature and determining category information of the video based on the linear transformation-processed target object representation.

The generating of the panorama segmentation result may include generating the panorama segmentation result using a trained panorama segmentation model, and the panorama segmentation model may be trained using a target loss function based on a sample panorama segmentation result corresponding to a training video, one or more prediction object representations of the training video determined through a first module configured to implement one or more portions of a panorama segmentation model, and one or more prediction results of the training video determined through a second module configured to implement one or more other portions of the panorama segmentation model.

An electronic device may include: one or more processor; and one or more memories storing instructions that, when executed by one or more processors, configure the one or more processors to perform any one, any combination, or all of operations and/or methods described herein.

In one or more general aspects, a non-transitory computer-readable storage medium stores instructions that, when executed by a processor, configure the processor to perform any one, any combination, or all of operations and/or methods described herein.

In one or more general aspects, an electronic apparatus includes: one or more processors configured to: obtain a video feature of a video comprising a plurality of video frames; determine a target object representation of the video based on the video feature using a neural network; and generate a panorama segmentation result of the video based on the target object representation.

In one or more general aspects, a processor-implemented method includes: obtaining training data, wherein the training data may include a training video, a first video feature of the training video, and a sample panorama segmentation result corresponding to the training video; generating a second video feature by changing a frame sequence of the first video feature; determining, through a first module configured to implement one or more portions of a panorama segmentation model, a first prediction object representation and a second prediction object representation of the training video based on the first video feature and the second video feature, respectively; determining, through a second module configured to implement one or more other portions of the panorama segmentation model, a first prediction result and a second prediction result of the training video based on the first prediction object representation and the second prediction object representation, respectively; and training the panorama segmentation model using a target loss function based on the sample panorama segmentation result, the first prediction object representation, the second prediction object representation, the first prediction result, and the second prediction result.

The training of the panorama segmentation model using the target loss function based on the sample panorama segmentation result, the first prediction object representation, the second prediction object representation, the first prediction result, and the second prediction result may include: determining a first similarity matrix based on the first prediction object representation and the second prediction object representation; determining a second similarity matrix based on the sample panorama segmentation result, the first prediction result, and the second prediction result; and outputting a trained panorama segmentation model in response to the target loss function being determined to be minimum based on the first similarity matrix and the second similarity matrix.

The method may include, using the trained panorama segmentation model: obtaining a video feature of a video comprising a plurality of video frames; determining a target object representation of the video based on the video feature using a neural network of the trained panorama segmentation model; and generating a panorama segmentation result of the video based on the target object representation.

Other features and aspects will be apparent from the following detailed description, the drawings, and the claims.

### BRIEF DESCRIPTION OF THE DRAWINGS

FIG. 1 illustrates an example of a method of processing a video.

FIG. 2 illustrates an example of a panorama segmentation.

FIG. 3 illustrates an example of a process of determining a clip query visualization.

FIG. 4 illustrates an example of a network architecture of a panorama segmentation model.

FIG. 5 illustrates an example of a panorama segmentation algorithm.

FIG. 6A illustrates an example of a framework of a masked decoder.

FIG. 6B illustrates an example of a framework of a masked decoder.

FIG. 7A illustrates an example of a framework of a hierarchical interaction module (HIM).

FIG. 7B illustrates an example of a framework of an HIM.

FIG. 8 illustrates an example of a framework of a clip feature query interaction module shown in FIGS. 7A and 7B.

FIG. 9 illustrates an example of a framework of a clip frame query interaction module shown in FIG. 7B.

FIG. 10 illustrates an example of a structure of a masked attention module shown in FIG. 8.

FIG. 11 illustrates an example of a structure of a frame query generation module shown in FIG. 9.

FIG. 12 illustrates an example of a structure of a mutual attention module shown in FIG. 9.

FIG. 13 illustrates an example of a structure of a segmentation head module.

FIG. 14 illustrates an example of a process of training a panorama segmentation model.

FIG. 15 illustrates an example of an effect contrast diagram.

FIG. 16 illustrates an example of an effect contrast diagram.

FIG. 17 illustrates an example of an effect contrast diagram.

FIG. 18 illustrates an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The phrases “at least one of A, B, and C,” “at least one of A, B, or C,” and the like are intended to have disjunctive meanings, and these phrases “at least one of A, B, and C,” “at least one of A, B, or C,” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Artificial intelligence (AI) is a technology and application system that may simulate, extend, and expand human intelligence, recognize the environment, acquire knowledge using a digital computer or a machine controlled by the digital computer, and obtain the best result using the knowledge. That is, AI is comprehensive technology of computer science that may understand the nature of intelligence and produce a new intelligent machine that may respond similarly to human intelligence. AI may cause a machine implementing the AI to have a function of recognizing, inferring, and determining by studying a design principle and an implementation method of various intelligent machines. AI technology is a comprehensive discipline that covers a wide range of fields including both hardware-side technologies and software-side technologies. The basic technology of AI generally includes technologies such as a sensor, a special AI chip, cloud computing, distributed storage, big data processing technology, an operation and/or interaction system, and/or electromechanical integration. AI software technology mainly includes major directions such as computer vision (CV) technology, voice processing technology, natural language processing technology, machine learning (ML) and/or deep learning, autonomous driving, and/or smart transportation.

In examples, the present disclosure relates to ML and CV technology, which are cross-disciplinary of various fields related to various departments such as probability theory, statistics, approximation theory, convex analysis, and/or algorithmic complexity theory. The present disclosure may improve performance by acquiring new knowledge or skills by simulating or implementing human learning behaviors and reconstructing existing knowledge structures. ML is the core of AI and a fundamental way to intelligentize computers and is applied to various fields of AI. ML and deep learning generally include technologies such as an artificial neural network, a trust network, reinforcement learning, transfer learning, inductive learning, and/or formal learning. CV is the science that studies how machines “see”, e.g., machine vision that identifies and measures an object using a camera and computer instead of human eyes, and further, is performing computational processing to better suit human eye observation or device detection of an image through graphic processing. As a scientific field, CV tries to build an AI system that may obtain information from an image or multi-dimensional data by studying related theories and technologies. CV technology generally includes technologies such as image processing, image recognition, image semantic understanding, image retrieval, optical character recognition (OCR), video processing, video semantic understanding, video content and/or action recognition, three-dimensional (3D) object reconstruction, 3D technology, virtual reality, augmented reality, and synchronous positioning, mapping, autonomous driving, and smart transportation, and also includes general biometric technologies such as face recognition and fingerprint recognition.

The present disclosure proposes a method of processing a video, an electronic device, a storage medium, and a program product, for example, may implement robust clip-object-centric representation learning for a video panoptic segmentation algorithm, and for the implementation of the method, an object tracking module may not be required, an algorithm structure may be simplified, and at the same time, the accuracy and robustness of a segmentation may be improved to a certain level.

Hereinafter, several examples are described. The implementation methods may be cross-referenced or combined, and the same terms, similar functions, and similar implementation operations among different implementation methods are not repeatedly described.

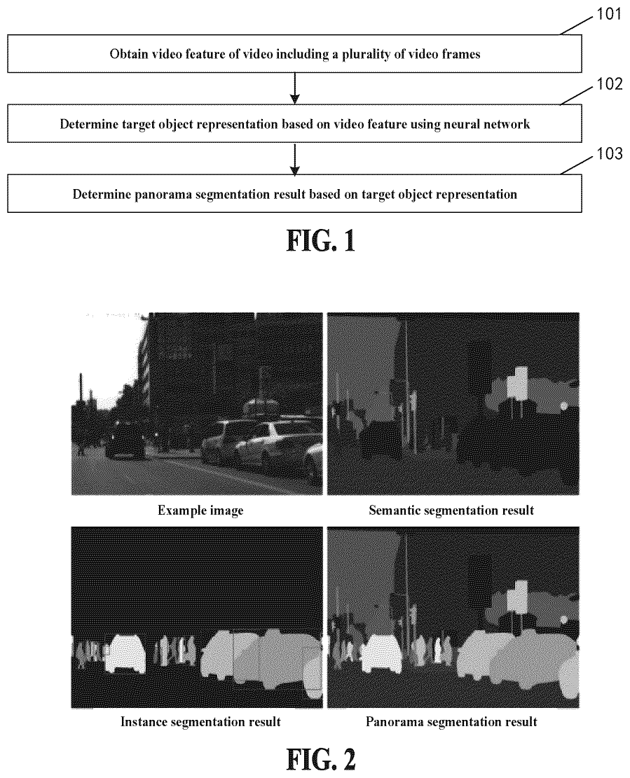

FIG. 1 illustrates an example of a method of processing a video. In an example of FIG. 1, the method may be executed by any electronic device such as a terminal or a server. The terminal may be a smartphone, tablet, notebook, desktop computer, smart speaker, smart watch, vehicle-mounted device, and/or the like. The server may be an independent physical server, a server cluster including various physical servers, or a distributed system, and/or may be a cloud server that provides a basic cloud computing service such as a cloud service, cloud database, cloud computing, cloud function, cloud storage, network service, cloud communication, middleware service, domain name service, security service, content delivery network (CDN), big data, and/or AI platform but is not limited thereto.

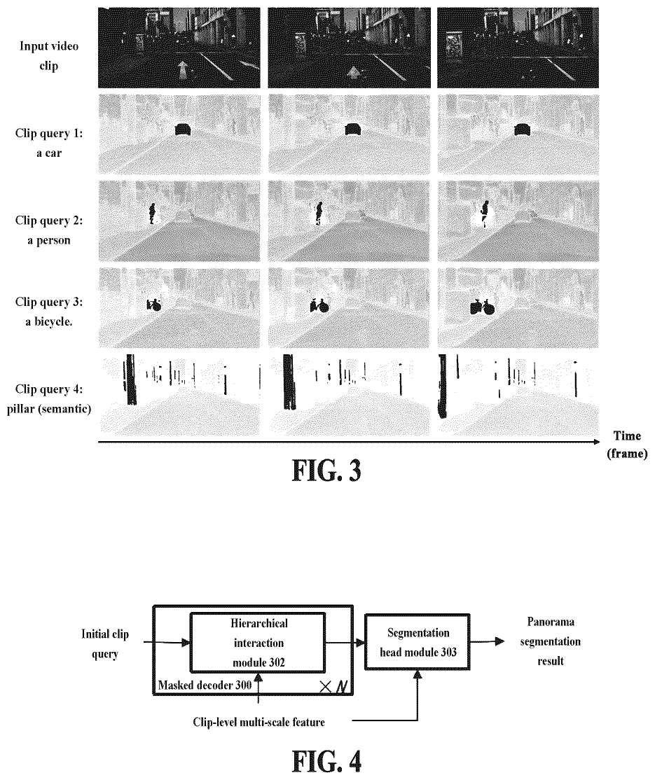

To better explain an example, a panorama segmentation scene is described below with reference to FIGS. 2 and 3.

FIG. 2 illustrates an example of a panorama segmentation. An image panorama segmentation is a process that may assign label information (e.g., semantic label and instance label information) to each pixel of a two-dimensional (2D) image. Image content may be divided into two categories, one type is a ‘stuff’, which may refer to content that is not to be distinguished between different objects (e.g., such as grass, the sky, and buildings) and may predict a semantic label as shown in a semantic segmentation result of FIG. 2. Another type is a ‘thing’, which may refer to content that is to be distinguished between different objects (e.g., such as people and cars) and may predict an instance label as shown in an instance segmentation result of FIG. 2. The panorama segmentation task may be regarded as a complex task of the semantic segmentation and the instance segmentation as shown in a panorama segmentation result of FIG. 2.

A video panorama segmentation may be an expansion of the image panorama segmentation in the time domain. For example, in addition to performing the panoramic segmentation on each frame of an image, the video panoramic segmentation may also combine object tracking tasks, e.g., assign the same label to pixels belonging to the same instance in different images.

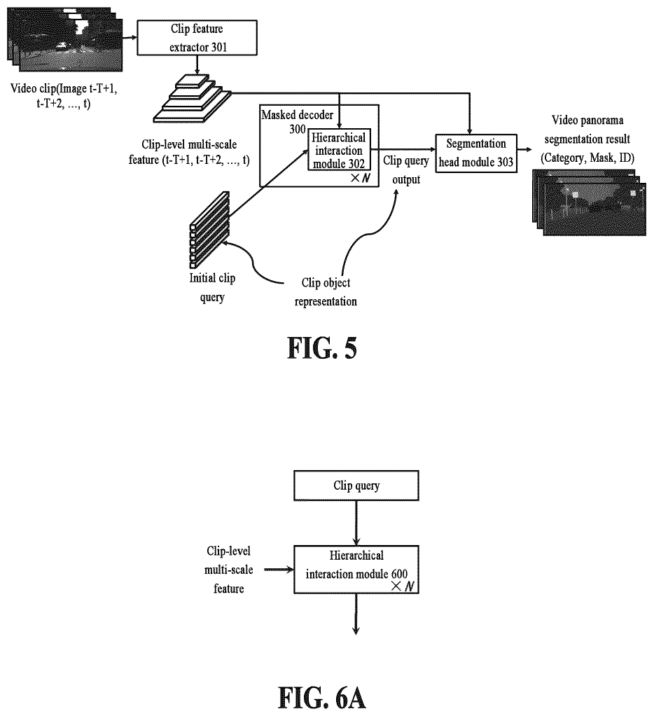

For a scene of the video panorama segmentation, a clip-level object representation may be proposed to represent a panoramic object in any video clip. For example, two contents, the ‘stuff’ and ‘thing’, may be uniformly represented as panorama objects. In the case of the ‘stuff’ contents (e.g., the sky, grass, etc.), all pixels of the same type in an image may form a panoramic object (e.g., all pixels of a sky category may form a sky panorama object). In the case of the “thing’ contents (e.g., pedestrians, cars, etc.), individuals may form a panorama object. A panoramic object representation of a single video frame may be referred to as a frame query, that is, an object representation for a single image. When processing a video clip, the panoramic object on the single frame may be processed as a panoramic object in the video clip, that is, as an object representation of a video (e.g., a clip-object representation as shown in FIG. 5), which may also be referred to as a clip query herein, and the clip query may be represented by one vector (e.g., where the length of the vector is C, where C may be one hyperparameter). Assuming that there are L clip queries on a video clip and L may be an integer greater than or equal to “0”, all clip panorama object representations on the video clip may form an LxC-dimensional matrix, e.g., all clip panorama object representations on the video clip may be a clip-object-centric representation.

For example, the clip query in the video clip may be expressed as Equation 1 below, for example.

$$Clip Query = [ \begin{matrix}[ \begin{matrix}{a}_{1 , 1} & … & {a}_{1 , C}\end{matrix} ] \\ ⋮ \\ [ \begin{matrix}{a}_{L , 1} & … & {a}_{L , C}\end{matrix} ]\end{matrix} ] \qquad Equation 1$$

In Equation 1, all clip queries of a video clip denote L vectors (the vector length is C), each vector denotes one clip-level object, and C is a vector dimension and denotes a hyperparameter that may be used to control the complexity of the clip-level object.

Alternatively or additionally, the clip query is a series of learnable parameters that may be randomly initialized in a network training process and progressively optimized through interaction with spatiotemporal information such as temporal domain and spatial information.

For example, as shown in FIG. 3, examples of four clip queries may be provided as a video frame progresses over time and each clip query may correspond one-to-one to a feature map of each video frame.

Hereinafter, dimensions and operators of some constants indicating a vector and tensor that may be included in the accompanying drawings are described.

T: indicates the length of a video clip, that is, the number of frames of the video clip.

L: indicates the maximum number of clip queries and is the number of panoramic objects in a clip.

C: indicates the channel dimension of a feature map and clip query.

H and W: indicate the resolution of an image (e.g., a video frame), where H is the height and W is the width of an image and indicate the length and width of a 2D image.

nc: indicates the total number of categories.

⊕: indicates an element-by-element addition operation.

⊗: indicates a matrix multiplication operation.

Hereinafter, a method of processing a video is described.

For example, as shown in FIG. 1, a method of processing a video may include operations 101 to 103. The operations 101 to 103 may be performed in the shown order and manner. However, the order of one or more of the operations 101 to 103 may be changed, one or more of the operations 101 to 103 may be omitted, and/or two or more of the operations 101 to 103 may be performed in parallel or simultaneously, without departing from the spirit and scope of the shown examples.

In operation 101, a video feature of a video may be obtained and the video may include at least two video frames.

In operation 102, a target object representation of the video may be determined based on the video feature using a neural network.

In operation 103, a panorama segmentation result of the video may be determined based on the target object representation.

For example, the method of processing a video may be implemented through a panorama segmentation model herein. As shown in FIG. 4, the panorama segmentation model may be implemented by a masked decoder 300, a hierarchical interaction module 302, and a segmentation head module 303. Alternatively or additionally, as shown in FIG. 5, the panorama segmentation model may further be implemented by a clip feature extractor 301. That is, the panorama segmentation model may process a feature map obtained by extracting a video (also referred to as a video clip, indicating data including at least two video frames) from other networks, and also extract a feature from an obtained video itself, and then process the extracted video feature.

The clip feature extractor 301 may include a universal feature extraction network structure such as a backbone (e.g., Res50-backbone) network and a pixel decoder for pixels, but is not limited thereto. Alternatively or additionally, as shown in FIG. 5, the clip feature extractor 301 may perform a feature extraction on an input video clip and extract a clip-level multi-scale feature.

For all frames of the input video clip (e.g., t-T+1, t-T+2, . . . , t, where T indicates the length of the video clip, that is, the number of video frames in the video clip), a video feature (also referred to as a clip feature) may be extracted through the clip feature extractor 301. Multiple frames or a single frame may be input to the clip feature extractor 301. In the case of a video including multiple video frames, the multiple video frames may be input together to the clip feature extractor 301 or each video frame may be input to the clip feature extractor 301 for each frame. Alternatively or additionally, a video feature may be extracted through a single frame input method to simplify the feature extraction task and improve the feature extraction rate.

The masked decoder 300 may include N hierarchical interaction modules (HIMs) 302, where N is an integer greater than or equal to “1”, such that the masked decoder 300 may include a plurality of cascaded HIMs 302. For example, the HIMs 302 at each level may have the same structure but different parameters. For example, the masked decoder 300 may determine the target object representation of a video based on an input video feature.

The segmentation head module 303 may output a segmentation result of a panorama object of a video clip based on the target object representation, such as a category, a mask, and/or an object identification (ID). For example, an obtained mask may be a mask of a clip panorama object defined in multiple frames and pixels belonging to the same mask in different frames may indicate a corresponding relationship of objects on the different frames. For example, the method of processing a video of one or more embodiments may automatically obtain an object ID without matching or tracking between different video frames. The mask may be understood as a template of an image filter. When extracting a target object from a feature map, a target object may be highlighted in response to filtering an image through an non matrix (the value of n may be considered based on elements such as a receptive field and accuracy, for example, may be set to 3*3, 5*5, 7*7, etc.).

Hereinafter, an interaction process is described.

In operation 102, the determining of the target object representation of the video based on the video feature using the neural network may include operation A1.

In operation A1, the target object representation of the video may be determined by performing multiple iteration processing on the video feature using the neural network.

Each iteration processing may include determining an object representation by current iteration processing of the video by performing iteration processing based on the video feature and an object representation by previous iteration processing of the video.

Alternatively or additionally, in case of a first iteration of the multiple iteration processing, the object representation by the previous iteration processing may be a pre-configured initial object representation.

Alternatively or additionally, the masked decoder 300 may include at least one HIM 302. When including at least two HIMs 302, each HIM 302 may be cascaded and aligned and an output of a previous level module may act as an input of the next level module. Based on the corresponding network structure, the masked decoder 300 may implement multiple iterations of a video feature. The number of iterations may be related to the number of HIMs 302 in the masked decoder 300.

The HIM 302 of a level may process the video feature of the corresponding video and the object representation (e.g., an output of the HIM 302 of the previous level) by the previous iteration processing and output the object representation by the current iteration processing. The input of a primarily aligned HIM 302 may include the video feature of video and the pre-configured initial object representation. The input of an aligned HIM 302 of the second and subsequent levels may include the corresponding video feature and an object representation (e.g., an object representation by the previous iteration processing) output by the HIM 302 in the previous level.

Alternatively or additionally, the initial object representation may be the same as compared to the video for which the panorama segmentation processing is to be performed.

As shown in FIGS. 4 and 5, the input of the primary HIM 302 in the masked decoder 300 may further include an initial clip query (also referred to as an initial object representation, that is, an obtained parameter from network training) in addition to the video feature extracted by the clip feature extractor 301, and the clip query input by the HIM 302 of the subsequent level may be the clip query output by the HIM 302 of the previous level. For example, the masked decoder 300 may obtain a certain query (e.g., a target object representation, that is, the output of the clip query shown in FIG. 5) of the corresponding video clip by performing a relational operation between the clip query and the video feature.

The algorithm process may perform a relational operation between a clip query and a video feature extracted from a video clip and align each clip query with a certain clip panorama object on the video clip until finally obtaining a segmentation result of a clip panorama object.

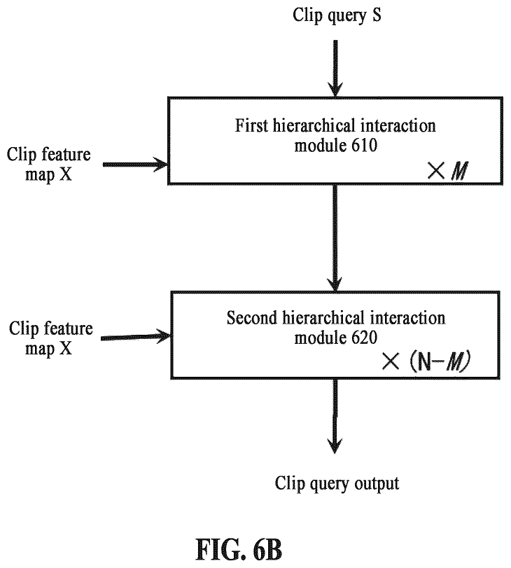

As shown in FIG. 6A, the masked decoder may include N identical HIMs 600. Alternatively or additionally, as shown in FIG. 6B, the HIM may be divided into a first HIM 610 and a second HIM 620. That is, the masked decoder may include M first HIMs 610 and N-M second HIMs 620, where M is less than or equal to N.

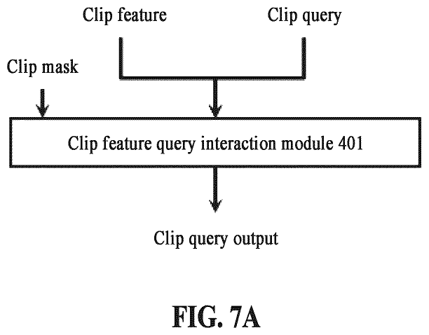

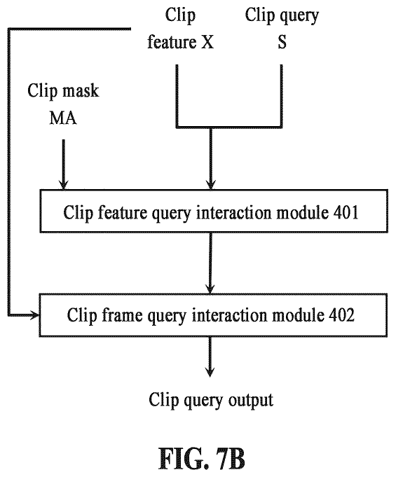

As shown in FIG. 7A, a network structure of the first HIM 610 may include a clip feature query interaction module 401, and as shown in FIG. 7B, the second HIM 620 may include the clip feature query interaction module 401 and a clip frame query interaction module 402. That is, the first HIM 610 may be a simplified network of the second HIM 620.

Alternatively or additionally, the masked decoder may include any combination of the first HIM 610 and the second HIM 620.

Alternatively or additionally, when the HIM adopted by the masked decoder includes the clip feature query interaction module 401, in operation A1, the determining of the object representation by the current iteration processing of the video by performing the iteration processing based on the video feature and the object representation by the previous iteration processing of the video may include operations A11 to A13.

In operation A11, a mask may be obtained by transformation processing an object representation by a previous iteration processing.

In operation A12, a first object representation may be obtained by processing the video feature, the object representation by the previous iteration processing, and the mask.

In operation A13, an object representation for a current iteration may be determined based on the first object representation.

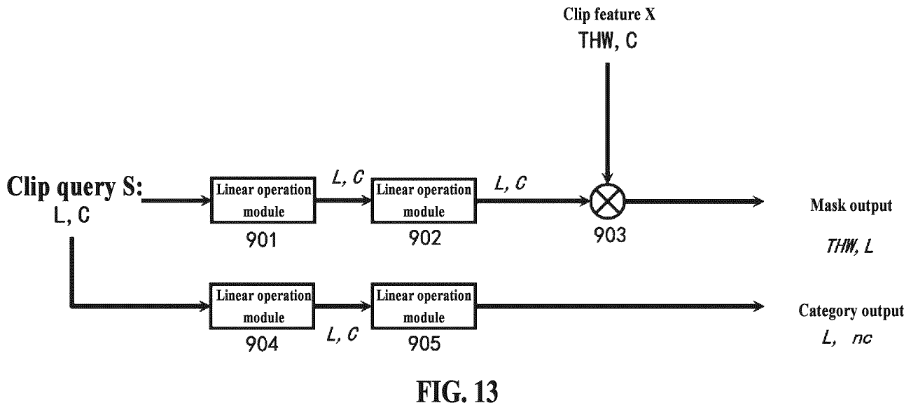

The transformation of the object representation by the previous iteration in operation A11 may be processed through a mask branch of a network structure, as shown in FIG. 13. That is, in response to performing multiple linear transformation processing on the object representation by the previous iteration processing, a transformed mask may be finally obtained by performing matrix multiplication with the video feature.

As shown in FIGS. 7A and 7B , in the current iteration processing, data input to the clip feature query interaction module 401 may include the video feature (e.g., a clip feature X) obtained in operation 101 and the object representation (when the current iteration is the first time, a clip query S may be an initial clip query as shown in FIG. 5, and when the current iteration is not the first time, the clip query S may be a clip query output from the HIM of the previous level) by the previous iteration processing and a binary mask (e.g., a clip mask MA) obtained by transformation processing the object representation by the previous iteration processing. In response to processing the clip query and feature map, a clip query output, which is also referred to as the first object representation, may be obtained. Alternatively or additionally, the first object representation may be directly used as the object representation by the current iteration processing.

The processing implemented by the clip feature query interaction module 401 may obtain location and appearance information of an object from all pixels of a clip feature. The influence of extraneous areas may be removed using the mask, and the learning process may be accelerated.

The obtaining of the first object representation by processing the video feature, the object representation by the previous iteration processing, and the mask in operation A12 may include the following operations A121 and A122.

In operation A121, an object representation related to a mask may be obtained by performing attention processing on the video feature, the object representation by the previous iteration processing, and the mask.

In operation A122, the first object representation may be obtained by performing self-attention processing and classification processing based on the object representation related to the mask and the object representation by the previous iteration processing.

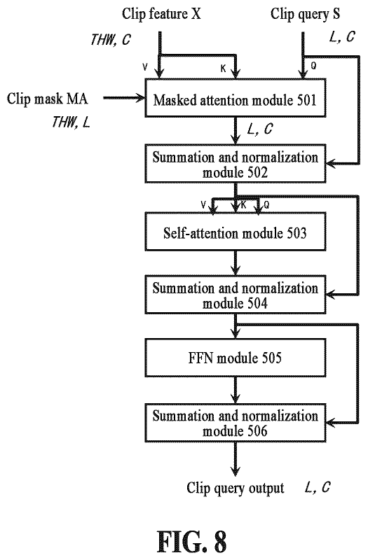

As shown in FIG. 8, processing may be performed on the input clip feature X (e.g., a video feature), the clip query S (e.g., an object representation by previous iteration processing), and the clip mask MA (transformed from the object representation by the previous iteration processing) using a masked attention module 501 and a segmentalized clip query may be obtained. Based on this, the processing result of operation A121 may be element-by-element added to the clip query S and the added sum result may be normalized (implemented through a summation and normalization module 502 shown in FIG. 8). Thereafter, self-attention processing may be performed on a normalized result A through a self-attention module 503, an output result may be added to the normalized result A element-by-element, and the added sum result may be normalized (implemented through a summation and normalization module 504 shown in FIG. 8). Then, through a feed forward network (FFN) module 505, a feed forward operation (e.g., classification processing) may be performed on a normalized result B, an output result may be added to the normalized result B element-by-element, the added sum result may be normalized (implemented through a summation and normalization module 506 shown in FIG. 8), and a clip query output (e.g., the first object representation) may be obtained.

As shown in FIG. 8, in the self-attention module 503, input Q, K, and V may correspond to the dimension L, C of a clip query (e.g., the normalized result A).

Alternatively or additionally, in the network structure shown in FIG. 8, the processing sequence of the FFN module 505 and other modules including an attention mechanism may be exchanged. In the network structure shown in FIG. 8, when the locations of the self-attention module 503 and the FFN module 505 may be exchanged, an output of the summation and normalization module 502 in response to exchanging may be used as an input of the FFN module 505.

Alternatively or additionally, in operation A121, the obtaining of the object representation related to the mask by performing the attention processing on the video feature, the object representation by the previous iteration processing, and the mask may include the following operations A121a to A121c.

In operation A121a, a second object representation may be obtained based on a key feature corresponding to the video feature, the object representation by the previous iteration processing, and the mask.

In operation A121b, a first probability indicating an object category in the video may be determined based on the second object representation.

In operation A121c, the object representation related to the mask may be obtained based on the first probability, a value feature corresponding to the video feature, and the video feature.

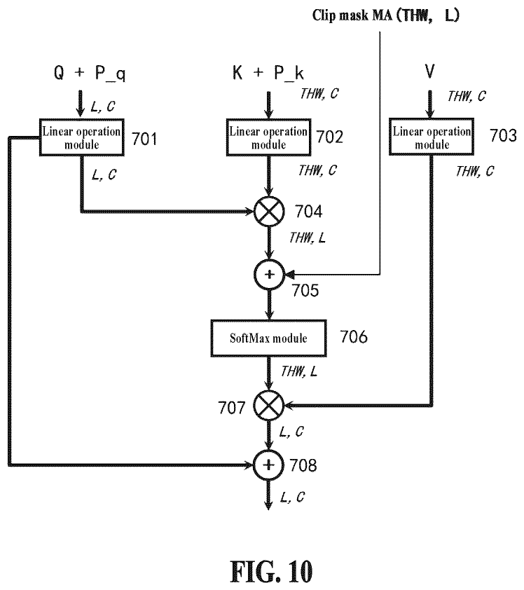

The input and output in operations A121a to A121c may be a tensor, and the dimension of the tensor may refer to FIG. 10.

First, a linear task may be performed on each of the input Q (e.g., a clip query, an object representation by previous iteration processing, corresponding to the dimension L, C), K (using a video feature as a key feature, corresponding to the dimension THW, C), and V (using a video feature as a value feature, corresponding to the dimension THW, C). Linear operation modules 701, 702, and 703 shown in FIG. 10 may include at least one linear operation layer. A matrix multiplication operation may be performed on an output of the linear operation module 701 and an output of the linear operation module 702 through a module 704, an output result of the module 704 may be added to the clip mask MA element-by-element through a module 705, and thus, a SoftMax operation (may be performed in the dimension THW) may be performed on an output (e.g., the second object representation) of the module 705 for transforming the output of the module 705 to the first probability corresponding to a category through a SoftMax module 706. The first probability may indicate all object categories in a video, for example, when the category is a car, the probability may be x, and when the category is a lamppost, the probability may be y. Based on this, an output (a transformed first probability) of the SoftMax module 706 may be matrix multiplied by a value feature in response to linear transformation processing through a module 707 and a result output by the module 707 may be overlapped with a video feature in response to linear transformation processing through a module 708 element-by-element, so a final clip query output (e.g., an object representation related to a mask) may be obtained.

Location information P_q and P_k shown in FIG. 10 are location information corresponding to Q and K and may be generated by a universal location information encoding module, and the location information may be optional for the masked attention module 501.

Alternatively or additionally, when the HIM adopted by the masked decoder includes the clip feature query interaction module 401 and the clip frame query interaction module 402, in operation A13, the determining of the object representation by the current iteration processing based on the first object representation may include the following operations A131 and A132.

In operation A131, an object representation corresponding to each video frame among at least one video frame may be determined based on the video feature and the first object representation.

In operation A132, an object representation by the current iteration processing may be determined based on an object representation corresponding to the first object representation and a determined video frame.

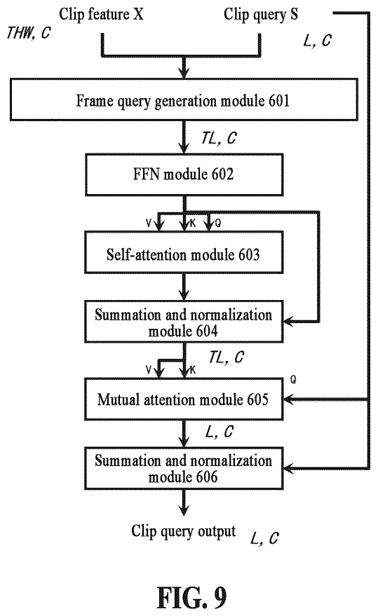

For example, as shown in FIG. 9, the input clip feature X (e.g., the video feature) and the clip query S (e.g., the output of the clip feature query interaction module 401 and the first object representation) may be processed through a frame query generation module 601, so a frame query on [1, T] frame (where T indicates the number of video frames in a video) may be obtained. For each C-dimensional clip query vector, a C-dimensional frame query vector may be obtained for each frame of the T frame, such that the overall dimension may be changed from L, C to TL, C.

As shown in FIG. 7B, in the current iteration processing, in response to obtaining the clip query output by the clip feature query interaction module 401, the final output (e.g., the object representation by the current iteration processing) of the HIM at the current level may be obtained by performing processing between the corresponding clip query and frame query (e.g., the object representation corresponding to each video frame).

Alternatively or additionally, the first object representation may be processed as at least one frame query or frame queries corresponding one-to-one to all video frames in a video, respectively.

Alternatively or additionally, in operation A131, the determining of the object representation corresponding to each video frame among at least one video frame based on the video feature and the first object representation may include the following operations A131a to A131c.

In operation A131a, a fourth object representation may be determined based on a key feature corresponding to the video feature and the first object representation.

In operation A131b, a second probability indicating an object category in the video may be determined based on the fourth object representation.

In operation A131c, an object representation corresponding to each video frame among at least one video frame may be determined based on the second probability and a value feature corresponding to the video feature.

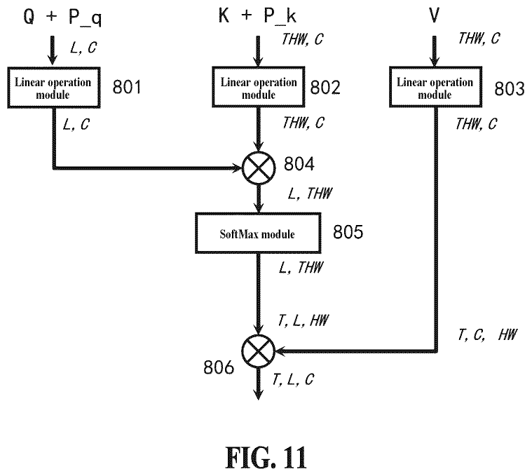

For example, the input and output of operations A131a to A131c may be a tensor and the dimension of the tensor may refer to FIG. 11.

First, a linear task may be performed on each of the input Q (e.g., the clip query, the first object representation, that is, the output of operation A12, corresponding to the dimension L, C), K (using a video feature as a key feature, corresponding to the dimension THW, C), and V (using a video feature as a value feature, corresponding to the dimension THW, C). Linear operation modules 801, 802, and 803 shown in FIG. 11 may include at least one linear operation layer. A matrix multiplication operation may be performed (executed through a module 804) on an output of the linear operation module 801 and an output of the linear operation module 802, and thus, a SoftMax operation may be performed on an output result (e.g., the fourth object representation) of the module 804 for transforming the output result of the module 804 to the second probability (executed through a SoftMax module 805 and the second probability may indicate an object category in a video) corresponding to a category. Based on this, a final frame query (e.g., an object representation corresponding to each video frame among at least one video frame) may be obtained by performing a matrix multiplication operation on a value feature in response to linear transformation processing through a module 806 and an output (e.g., the second probability) of the SoftMax module 805.

Alternatively or additionally, a reshape task may be performed on the input of the module 806 and the dimension change of a tensor may refer to FIG. 11.

Location information P_q and P_k shown in FIG. 11 are location information corresponding to Q and K and may be generated by a universal location information encoding module, and the location information may be optional for the frame query generation module 601.

In operation A132, the determining of the object representation by the current iteration processing based on the first object representation and the object representation corresponding to the determined video frame may include the following operations B1 and B2.

In operation B1, a third object representation corresponding to the video may be obtained by performing classification processing and self-attention processing on the object representation corresponding to the determined video frame.

In operation B2, the object representation by the current iteration processing may be determined based on the first object representation and the third object representation.

Alternatively or additionally, all inputs and outputs of operation of the clip frame query interaction module 402 may be tensors and the dimension of the tensors is illustrated in FIG. 9.

As shown in FIG. 9, a feed forward operation (e.g., the classification processing) may be performed on a result (e.g., the object representation corresponding to the determined video frame) of the output of the frame query generation module 601 through an FFN module 602 and self-attention processing may be performed on a result of the output of the FFN module 602 through a self-attention module 603. Then, a result in response to the self-attention processing may be overlapped on the result of the output of the FFN module 602 element-by-element and the added sum result may be normalized (implemented through a summation and normalization module 604 shown in FIG. 9), so a result C (e.g., the third object representation) obtained by normalizing may be obtained. Based on this, a mutual attention calculation may be performed on the result C obtained by normalizing and the input clip query S through a mutual attention module 605, and here, the dimension of the output of the mutual attention module 605 may be L, C, which is the same as the clip query S. Finally, the result of the output of the mutual attention module 605 may be added to the clip query S element-by-element and a result D obtained by normalizing (implemented through a summation and normalization module 606 shown in FIG. 9) may be obtained by normalizing the added sum result. That is, d is a clip query output of the clip frame query interaction module 402 (e.g., the target object representation by the current iteration process).

As shown in FIG. 9, in the self-attention module 603, the input Q, K, and V may correspond to the dimension TL, C of the result of the output of the FFN module 602.

Alternatively or additionally, in the network structure shown in FIG. 9, the processing sequence of the FFN module 602 and other modules including an attention mechanism may be exchanged. In the network structure shown in FIG. 9, when the locations of the self-attention module 603 and the FFN module 602 may be exchanged, the output of the frame query generation module 601 in response to exchanging may be used as an input of the self-attention module 603 and an output of the self-attention module 603 may be used as an input of the FFN module 602.

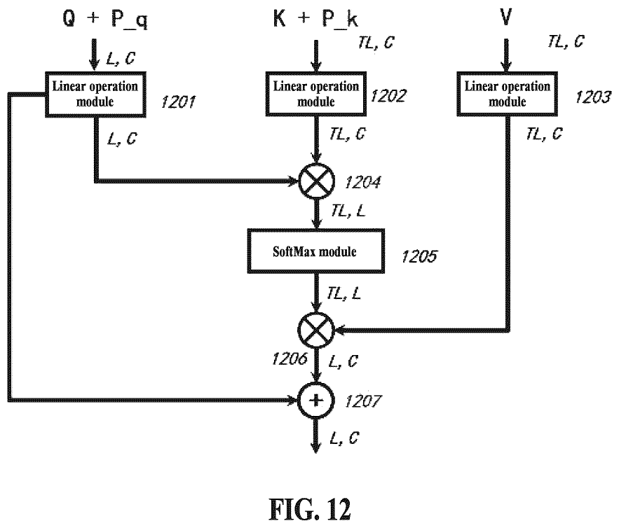

Alternatively or additionally, a certain network structure of the mutual attention module 605 shown in FIG. 9 may refer to the structure shown in FIG. 12.

First, a linear task may be performed on each of the input Q (e.g., the clip query, the first object representation, that is, the output of the clip feature query interaction module 401, corresponding to the dimension L, C), K (using the result of the output of the summation and normalization module 604 as a key feature, corresponding to the dimension TL, C), and V (using the result of the output of the summation and normalization module 604 as a value feature, corresponding to TL, C). Linear operation modules 1201, 1202, and 1203 shown in FIG. 12 may include at least one linear operation layer. A matrix multiplication operation may be performed (executed through a module 1204) on an output result of the linear operation module 1201 and an output result of the linear operation module 1202, and thus, a SoftMax operation may be performed on an output result of the module 1204 for transforming the output result of the module 1204 to a third probability (executed through the SoftMax module 1205) corresponding to a category. Based on this, a matrix multiplication operation may be performed on a value feature of a video feature in response to linear transformation processing through the module 1206 and an output (e.g., the third probability) of the SoftMax module 1205, an output of the module 1206 may be overlapped with the input Q in response to being linear transformation processed through a module 1207, and a mutual attention output of the mutual attention module 605 may be obtained.

Location information P_q and P_k shown in FIG. 12 are location information corresponding to Q and K and may be generated by a universal location information encoding module, and the location information may be optional for the mutual attention module 605.

Hereinafter, a video panorama segmentation process is described.

For example, in operation 103, the determining of the panoramic segmentation result of the video based on the target object representation may include the following operations S103a and S103b.

In operation S103a, linear transformation processing may be performed on the target object representation.

In operation S103b, mask information of the video may be determined based on the target object representation in response to being linear transformation processed and the video feature and category information of the video may be determined based on the target object representation in response to being linear transformation processed.

As shown in FIG. 13, an input of the segmentation head module may include the clip query S (e.g., the output of the masked decoder) and the clip feature X, and the output of the segmentation head module may be predicted mask information (e.g., an output of a module 903) and category information (e.g., an output of a linear operation module 905). For example, the segmentation head module may be divided into two branches: one may be a mask branch including linear operation modules 901 and 902, and the module 903, and the other one may be a category branch including linear operation modules 904 and 905.

In the mask branch, the linear transformation may be first performed on the clip query S and the output of the linear operation module 901 may be obtained and then the linear transformation may be performed on the output of the linear operation module 901 and the output of the linear operation module 902 may be obtained (e.g., several linear operation modules, such as one, two, or three, may be set in the mask branch and the number of linear operation modules in the mask branch is not limited thereto). Based on this, a matrix multiplication operation may be performed on the output of the linear operation module 902 and the clip feature X and a mask output may be obtained. The mask output (e.g., mask information) shown in FIG. 13 may belong to a clip level, and an object ID may be automatically obtained without matching or tracking between different video frames. That is, the mask information output by the mask branch may include a mask and an object ID.

In the category branch, the linear transformation may be first performed on the clip query S and the output of the linear operation module 904 may be obtained and then the linear transformation may be performed on the output of the linear operation module 904 and the output of the linear operation module 905 may be obtained (e.g., several linear operation modules, such as one, two, or three, may be set in the category branch and the number of linear operation modules in the category branch is not limited thereto). That is, the output of the linear operation module 905 is a category output (e.g., category information) shown in FIG. 13.

Alternatively or additionally, when the number of frames of a video clip is greater than “1”, since the mask information output from the mask branch belongs to a clip level, object IDs of all frames of the video may be automatically obtained. Accordingly, the category information output from the category branch may be semantic information of an object (e.g., a car, person, etc.).

Hereinafter, a process of training a panorama segmentation model is described.

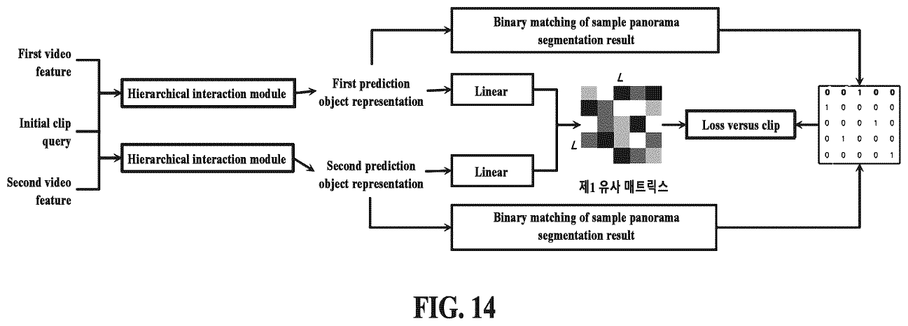

For example, when training a network, a prediction result (e.g., the mask and category) needs to be limited similar to the mask and category of a ground-truth (GT) label, which may be achieved by minimizing a loss function. As shown in FIG. 14, a corresponding relationship between a prediction mask and a GT mask may be set using a binary matching algorithm. The loss function used here may include several items such as cross-entropy loss at a pixel level, panorama quality loss at a panoramic object level, mask ID loss, and mask similarity loss (e.g., a Dice-based calculation).

The training of the panoramic segmentation model may include the following operations B1 and B2.

In operation B1, training data may be obtained. The training data may include a training video, a first video feature of the training video, and a sample panorama segmentation result corresponding to the training video.

In operation B2, a trained panorama segmentation model may be obtained by training the panorama segmentation model based on the training data. In training, the following operations B21 to B24 may be performed.

In operation B21, a second video feature may be obtained by changing the frame sequence of the first video feature.

In operation B22, a first prediction object representation and a second prediction object representation of the training video may be determined based on the first video feature and the second video feature, respectively, through the HIM (e.g., a first module).

In operation B23, a first prediction result and a second prediction result of the training video may be determined based on the first prediction object representation and the second prediction object representation, respectively, through the segmentation head module (i.e., a second module).

In operation B24, the panorama segmentation model may be trained using a target loss function based on the sample panorama segmentation result, the first prediction object representation, the second prediction object representation, the first prediction result, and the second prediction result.

Alternatively or additionally, a replaced frame feature map X′ (e.g., a second video feature shown in FIG. 14) may be obtained by replacing the frame sequence of a clip feature map X (e.g., a first video feature shown in FIG. 14). The X and X′ may obtain two sets of clip query outputs out_S (e.g., the first prediction object representation) and out_S′ (e.g., the second prediction object representation) through the HIM, respectively. In network training, clip query vectors corresponding to the same clip panorama object of the out_S and out_S′ must be similar and clip query vectors corresponding to different clip panorama objects must not be similar. The out_S (e.g., the first prediction object representation) and out_S′ (e.g., the second prediction object representation) may be processed by the segmentation head module and a first prediction result and a second prediction result may be obtained, respectively.

Alternatively or additionally, in operation B24, the training of the panorama segmentation model using the target loss function based on the sample panorama segmentation result, the first prediction object representation, the second prediction object representation, the first prediction result, and the second prediction result may include the following operations B241 to B243.

In operation B241, a first similarity matrix between object representations may be determined based on the first prediction object representation and the second prediction object representation.

In operation B242, a second similarity matrix between segmentation results may be determined based on the sample panorama segmentation result, the first prediction result, and the second prediction result.

In operation B243, when a target loss function is determined to be minimum based on the first similarity matrix and the second similarity matrix, a trained panorama segmentation result may be output.

For example, the target loss function (e.g., the loss function versus the clip) may be expressed as Equation 2 below, for example.

L_{clip_contra}=Ave(−W*[Y*log(X)+(1−Y)*log(1−X)]) Equation 2:

X denotes a similarity matrix (e.g., a similarity between vectors may be calculated using a method such as a general cosine similarity) calculated between the out_S and out_S′ and Y denotes a similarity matrix of a GT and may be referred to as a GT matrix (as shown in FIG. 14, when two clip query vectors correspond to a clip panorama object of the same GT, a corresponding location value of Y may be “1”, and otherwise “0”). W denotes a weight matrix, which has a value “1” for a location of the same category and otherwise “0” (there is no need to supervise considering that objects from other categories are obvious herein). In addition, in Equation 2, a multiplication sign “*” denotes element-by-element multiplication, while Ave( ) denotes an average of panoramic objects of all clips.

A network structure may be implemented using Python, which is a deep learning framework. Compared with the related art, this network may effectively reduce computational complexity while simplifying the network structure, thereby effectively improving segmentation accuracy and making full use of video information. Here, the accuracy may be measured using video panoptic quality (VPQ).

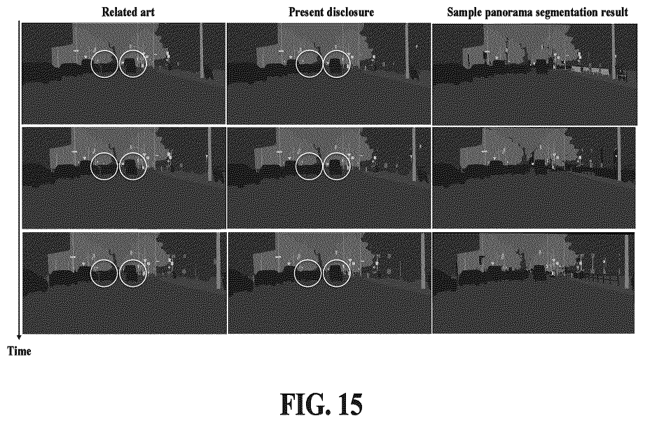

To better explain the technical effects that may be achieved herein, a segmentation result shown in FIGS. 15 to 17 is described below.

As shown in FIG. 15, both the panorama segmentation result obtained through related art and the sample panorama segmentation result that may be used for network training may not recognize a car between cars indicated by two circles (some instances are missing). The panorama segmentation result obtained using the video processing method according to the present disclosure may identify a car (e.g., a front car) located between cars (e.g., rear cars).

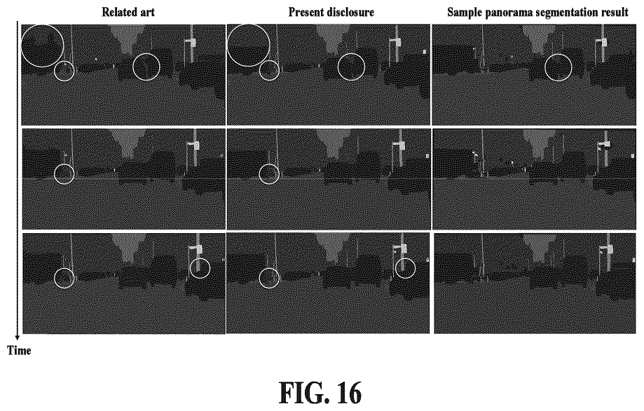

As shown in FIG. 16, in the panoramic segmentation result of the related art, a mask of a bicycle is incomplete, so an ID belonging to the bicycle may not be assigned and the smaller pedestrian in the third video frame may not be identified. In addition, a car (e.g., a front car) between cars (e.g., rear cars) in the first video frame may not be identified. In the sample panorama segmentation result used for network training, a car (e.g., marked with a circle) between cars in the first video frame may not be recognized. However, the panorama segmentation result obtained using the video processing method provided in the present disclosure may effectively compensate for disadvantages of the technology according to related art and the sample panorama segmentation result.

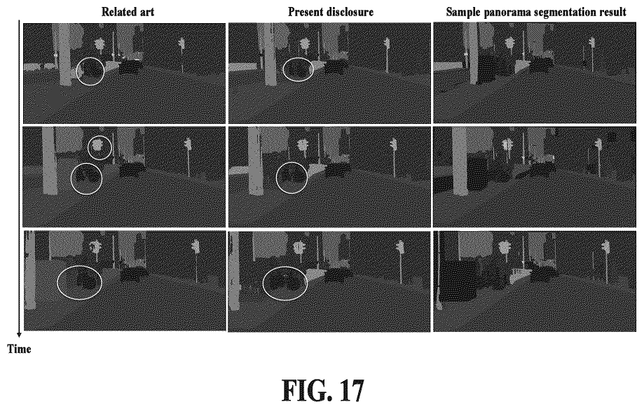

As shown in FIG. 17, the present disclosure may obtain a clearer bicycle contour representation, which means that better segmentation accuracy may be achieved. Compared with the sample panorama segmentation result used for network training, the segmentation result belonging to the bicycle obtained herein may be consistent in each video frame, while the segmentation result for the same bicycle in each video frame of the sample panorama segmentation result may be different, which means that better robustness may be achieved.

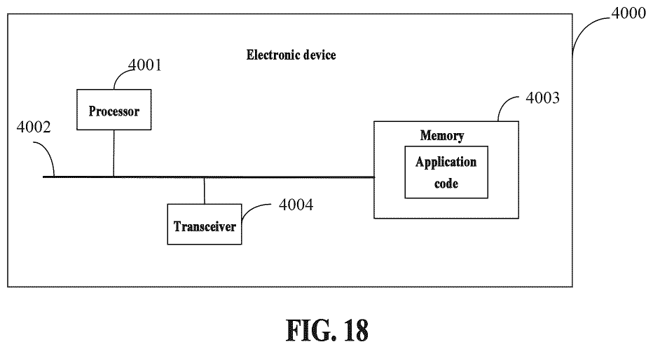

An electronic device may be provided. As shown in FIG. 18, an electronic device 4000 may include a processor 4001 (e.g., one or more processors) and a memory 4003 (e.g., one or more memories). The processor 4001 may be connected to the memory 4003 via, for example, a bus 4002. Alternatively or additionally, the electronic device 4000 may further include a transceiver 4004, in which the transceiver 4004 may be used for data interaction, such as data transmission and/or reception, between electronic devices. In actual application, the transceiver 4004 is not limited to one and the structure of the electronic device 4000 is not limited to an example of the present disclosure.

The processor 4001 may be a central processing unit (CPU), a general-purpose processor, a digital signal processor (DSP), an application-specific integrated circuit (ASIC), a field-programmable gate array (FPGA) or other programmable logic devices, a transistor logic device, a hardware component, or any combination thereof. The processor 4001 may implement or execute various illustrative logical blocks, modules, and circuits described herein. In addition, the processor 4001 may be, for example, a combination that realizes computing functions including a combination of one or more microprocessors or a combination of a DSP and a microprocessor.

The bus 4002 may include a path for transmitting information between the components described above. The bus 4002 may be a peripheral component interconnect (PCI) bus or an extended industry standard architecture (EISA) bus. The bus 4002 may be divided into an address bus, a data bus, a control bus, and the like. For convenience of description, only one thick line is shown in FIG. 18, but there may not only be one or one type of bus.

The memory 4003 may be read-only memory (ROM) or other type of static storage capable of storing static information and instructions, random-access memory (RAM) or other type of dynamic storage capable of storing information and instructions, erasable programmable read-only memory (EPROM), CD-ROM, other optical disc storage, optical disc storage (including a compressed optical disc, a laser disc, an optical disc, a digital versatile disc, a Blu-ray disc, etc.), disc storage media, other magnetic storage devices, or all other media that can be used to transport or store a computer program and read by a computer but is not limited thereto.

The memory 4003 may be used to store a computer program for executing an example of the present disclosure and controlled by the processor 4001. The processor 4001 may execute the computer program stored in the memory 4003 and implement operations described above. For example, the memory 4003 may be or include a non-transitory computer-readable storage medium storing instructions that, when executed by the processor 4001, configure the processor 4001 to perform any one, any combination, or all of the operations and methods described herein with reference to FIGS. 1-17.

According to the methods described above, at least one of a plurality of modules may be implemented through an AI model. AI-related functions may be performed by a non-volatile memory, a volatile memory, and the processor 4001.

The processor 4001 may include at least one processor. Here, at least one processor may be, for example, general-purpose processors (e.g., a CPU and an application processor (AP), etc.), or graphics-dedicated processors (e.g., a graphics processing unit (GPU) and a vision processing unit (VPU)), and/or AI-dedicated processors (e.g., a neural processing unit (NPU)).

At least one processor may control processing of input data according to a predefined operation rule or an AI model stored in a non-volatile memory and a volatile memory. The predefined operation rules or AI model may be provided through training or learning.

Here, providing the predefined operation rules or AI model through learning may indicate obtaining a predefined operation rule or AI model with desired characteristics by applying a learning algorithm to a plurality of pieces of training data. The training may be performed by a device having an AI function according to the disclosure, or by a separate server and/or system.

The AI model may include a plurality of neural network layers. Each layer has a plurality of weights, and the calculation of one layer may be performed based on a calculation result of a previous layer and the plurality of weights of the current layer. A neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network but is not limited thereto.

The learning algorithm may be a method of training a predetermined target device, for example, a robot, based on a plurality of pieces of training data and of enabling, allowing, or controlling the target device to perform determination or prediction. The learning algorithm may include, but is not limited to, for example, supervised learning, unsupervised learning, semi-supervised learning, or reinforcement learning.

A non-transitory computer-readable storage medium in which a computer program is stored may be provided herein. When the computer program is executed by the processor 4001, operations described above and corresponding contents of may be implemented.

A computer program product including a computer program capable of implementing operations described above and corresponding contents may be provided when executed by the processor 4001.

The terms “first”, “second”, “third”, “fourth”, “1”, “2”, etc. (when used herein) used in the specification and claims herein as well as the accompanying drawings may be used to distinguish similar objects without specifying a specific order or preceding order. It should be understood that an example of the present disclosure may be implemented in an order other than the drawings or descriptions, as data used in this manner may be exchanged where appropriate.

The modules may be implemented through software or neural networks. In some cases, the name module does not configure a limitation of the module itself, for example, the self-attention module may also be described as “a module for self-attention processing”, “a first module”, “a self-attention network”, “a self-attention neural network”, etc.

The masked decoders, clip feature extractors, HIMs, segmentation head modules, first HIMs, second HIMs, clip feature query interaction modules, clip frame query interaction modules, masked attention modules, summation and normalization modules, self-attention modules, FFN modules, frame query generation modules, mutual attention modules, linear operation modules, modules, SoftMax modules, electronic devices, processors, buses, transceivers, memories, masked decoder 300, clip feature extractor 301, HIM 302, segmentation head module 303, HIMs 600, first HIM 610, second HIM 620, clip feature query interaction module 401, clip frame query interaction module 402, masked attention module 501, summation and normalization module 502, self-attention module 503, summation and normalization module 504, FFN module 505, summation and normalization module 506, frame query generation module 601, FFN module 602, self-attention module 603, summation and normalization module 604, mutual attention module 605, summation and normalization module 606, linear operation modules 701, 702, and 703, module 704, module 705, SoftMax module 706, module 707, module 708, linear operation modules 801, 802, and 803, module 804, SoftMax module 805, module 806, linear operation modules 1201, 1202, and 1203, module 1204, SoftMax module 1205, module 1206, module 1207, linear operation modules 901, 902, 904, and 905, module 903, electronic device 4000, processor 4001, bus 4002, memory 4003, transceiver 4004, and other apparatuses, devices, units, modules, and components disclosed and described herein with respect to FIGS. 1-18 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-18 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
obtaining a video feature of a video comprising a plurality of video frames;
determining a target object representation of the video based on the video feature using a neural network; and
generating a panorama segmentation result of the video based on the target object representation.

2. The method of claim 1, wherein the determining of the target object representation of the video based on the video feature using the neural network comprises determining the target object representation of the video by performing multiple iteration processing on the video feature using the neural network.

3. The method of claim 2, wherein the determining of the target object representation of the video by performing the multiple iteration processing on the video feature using the neural network comprises determining an object representation by current iteration processing of the video by performing iteration processing based on the video feature and an object representation by previous iteration processing of the video, using the neural network.

4. The method of claim 3, wherein the object representation by the previous iteration processing is a pre-configured initial object representation in a case of first iteration processing of the multiple iteration processing.

5. The method of claim 3, wherein the determining of the object representation by the current iteration processing of the video by performing the iteration processing based on the video feature and the object representation by the previous iteration processing of the video comprises:
generating a mask by performing transformation processing on the object representation by the previous iteration processing of the video;
generating a first object representation by processing the video feature, the object representation by the previous iteration processing, and the mask; and
determining the object representation by the current iteration processing of the video based on the first object representation.

6. The method of claim 5, wherein the generating of the first object representation by processing the video feature, the object representation by the previous iteration processing, and the mask comprises:
generating an object representation related to a mask by performing attention processing on the video feature, the object representation by the previous iteration processing, and the mask; and
generating the first object representation by performing self-attention processing and classification processing based on the object representation related to the mask and the object representation by the previous iteration processing.

7. The method of claim 6, wherein the generating of the object representation related to the mask by performing the attention processing on the video feature, the object representation by the previous iteration processing, and the mask comprises:
generating a second object representation based on a key feature corresponding to the video feature, the object representation by the previous iteration processing, and the mask;
determining a first probability indicating an object category in the video based on the second object representation; and
generating the object representation related to the mask based on the first probability, a value feature corresponding to the video feature, and the video feature.

8. The method of claim 5, wherein the determining of the object representation by the current iteration processing of the video based on the first object representation comprises:
determining an object representation corresponding to each video frame of one or more video frames of the plurality of video frames, based on the video feature and the first object representation; and
determining the object representation by the current iteration processing of the video based on the first object representation and the determined object representation corresponding to the each video frame.

9. The method of claim 8, wherein the determining of the object representation corresponding to each video frame of the one or more video frames based on the video feature and the first object representation comprises:
determining a fourth object representation based on a key feature corresponding to the video feature and the first object representation;
determining a second probability indicating an object category in the video based on the fourth object representation; and
determining the object representation corresponding to each video frame of the one or more video frames based on the second probability and a value feature corresponding to the video feature.

10. The method of claim 8, wherein the determining of the object representation by the current iteration processing of the video based on the first object representation and the determined object representation corresponding to the each video frame comprises:
generating a third object representation corresponding to the video by performing classification processing and self-attention processing on the determined object representation corresponding to the each video frame; and
determining the object representation by the current iteration processing of the video based on the first object representation and the third object representation.

11. The method of claim 1, wherein the generating of the panorama segmentation result of the video based on the target object representation comprises:
performing linear transformation processing on the target object representation; and
determining mask information of the video based on the linear transformation-processed target object representation and the video feature and determining category information of the video based on the linear transformation-processed target object representation.

12. The method of claim 1, wherein
the generating of the panorama segmentation result comprises generating the panorama segmentation result using a trained panorama segmentation model, and
the panorama segmentation model is trained using a target loss function based on a sample panorama segmentation result corresponding to a training video, one or more prediction object representations of the training video determined through a first module configured to implement one or more portions of a panorama segmentation model, and one or more prediction results of the training video determined through a second module configured to implement one or more other portions of the panorama segmentation model.

13. A non-transitory computer-readable storage medium storing instructions that, when executed by one or more processors, configure the one or more processors to perform the method of claim 1.

14. An electronic apparatus comprising:
one or more processors configured to:
obtain a video feature of a video comprising a plurality of video frames;
determine a target object representation of the video based on the video feature using a neural network; and
generate a panorama segmentation result of the video based on the target object representation.

15. A processor-implemented method, the method comprising:
obtaining training data, wherein the training data comprises a training video, a first video feature of the training video, and a sample panorama segmentation result corresponding to the training video;
generating a second video feature by changing a frame sequence of the first video feature;
determining, through a first module configured to implement one or more portions of a panorama segmentation model, a first prediction object representation and a second prediction object representation of the training video based on the first video feature and the second video feature, respectively;
determining, through a second module configured to implement one or more other portions of the panorama segmentation model, a first prediction result and a second prediction result of the training video based on the first prediction object representation and the second prediction object representation, respectively; and
training the panorama segmentation model using a target loss function based on the sample panorama segmentation result, the first prediction object representation, the second prediction object representation, the first prediction result, and the second prediction result.

16. The method of claim 15, wherein the training of the panorama segmentation model using the target loss function based on the sample panorama segmentation result, the first prediction object representation, the second prediction object representation, the first prediction result, and the second prediction result comprises:
determining a first similarity matrix based on the first prediction object representation and the second prediction object representation;
determining a second similarity matrix based on the sample panorama segmentation result, the first prediction result, and the second prediction result; and
outputting a trained panorama segmentation model in response to the target loss function being determined to be minimum based on the first similarity matrix and the second similarity matrix.

17. The method of claim 15, further comprising, using the trained panorama segmentation model:
obtaining a video feature of a video comprising a plurality of video frames;
determining a target object representation of the video based on the video feature using a neural network of the trained panorama segmentation model; and
generating a panorama segmentation result of the video based on the target object representation.
